(19) United States
(12) Patent Application Publication
(10) Pub. No.: US 2017/0350142 A1
(43) Pub. Date: Dec. 7, 2017

(54) FLOORING COMPRISING A DECORATION PRINTED BY INK JET

(71) Applicant: GERFLOR, Villeurbanne (FR)

(72) Inventors: Charles Ferlay, Montrottier (FR); Gwenaëlle Charles, Tarare (FR)

(21) Appl. No.: 15/613,425

(22) Filed: Jun. 5, 2017

(30) Foreign Application Priority Data
Jun. 6, 2016 (FR) 1655117

(51) Int. Cl. E04F 15/10; B41M 5/00; B41M 5/025; E04F 15/02

(52) U.S. Cl. CPC E04F 15/107; B41M 5/0256; B41M 5/0047; E04F 15/02172

(57) ABSTRACT

Provided is a flooring comprising a multilayer structure comprising successively at least one wear layer, a decorative layer and a sublayer, wherein the decorative layer is in the form of a non-woven textile sheet impregnated with a binder and one of the faces of said non-woven textile sheet comprises a decoration printed with ink. The invention also provides a method for obtaining such flooring.

### TECHNICAL FIELD

The present invention concerns the technical sector of flooring and wall coverings using polyvinyl chloride or similar materials, and more particularly, flooring comprising a decoration printed by inkjet and the manufacturing method thereof.

### BACKGROUND

In the domain of flooring, composite floor tiles or panels based on at least one layer of plastic material, such as polyvinyl chloride (PVC), are well known. Such flooring usually comprises, at the surface, at least one transparent wear layer of plastic material, essentially of PVC, beneath which at least one layer—called the decorative layer—of plastic material, possibly foam, is disposed, on which a design or decoration is printed by rotogravure, with a layer—called support layer—generally consisting of a non-woven web, of glass fibers for example, embedded in a plastic material such as PVC. Moreover, the flooring can comprise, beneath the support layer, a resilient sub-layer composed for example of foam.

The designs or decorations are thus printed by a rotogravure method on a decorative layer. Rotogravure is a printing method by which the ink is transferred directly from the engraved metal cylinder onto the decorative layer, particularly adapted to very long printing of floorings. However, to produce designs and decorations it is often necessary to use several engraved metal cylinders which must be stored when not in use, thus increasing manufacturing costs. Now, these metal cylinders are particularly bulky. Moreover, new metal cylinders should be engraved for each new design or decoration, and since the manufacture of new metal cylinders is often lengthy and expensive, the cost of manufacturing flooring is burdensome.

In order to remedy these disadvantages, a well-known solution consists of using inkjet printing methods, which have the advantage of enabling a quick and inexpensive change of design or decoration. In particular, these methods use solvent inks which, although they have good chemical compatibility with the wear layer, produce strong emissions of volatile organic compounds (VOC), which are toxic and harmful to the environment.

Other techniques, particularly used in laminate floors, employee photo cross-linkable inks protected by a polyester resin layer. However, this polyester resin layer is rigid after drying, and is therefore incompatible with resilient flooring.

Another inkjet printing solution consists in the use of water-based solvent-free inks that do not emit volatile organic compounds; however, these solvent-free inks often have the disadvantage of not being chemically compatible with the support layer and the wear layer so that delamination of the support and wear layers appears quickly.

One solution utilizing a photo cross-linkable ink was disclosed in application EP 2875949 of the applicant. In this regard, the method proposed in said application is notable in that the pigment ink used is a liquid solvent-free ink deposited on the wear layer or on the support layer and covered with a bonding layer, said bonding layer being chemically compatible with the ink in solid-state forming the decoration printing layer and with the support layer or the wear layer. The liquid solvent-free pigment ink consists for example of an ink comprising urethane acrylates and/or ester acrylates. Furthermore, the bonding layer is produced, for example, from a material comprising an emulsion of acrylic and urethane and/or an acrylic copolymer. However, this method is complex in that it requires the use of a bonding layer as primer, thus lengthening the manufacturing processes and increasing the costs thereof.

### DESCRIPTION OF THE INVENTION

One of the purposes of the invention, therefore, is to remedy these disadvantages by proposing flooring, and the manufacturing method thereof, of a simple and inexpensive design, comprising a print layer obtained by an inkjet printing method, which can be compatible with inks that do not emit volatile organic compounds (VOC) and which can be flexible, particularly to be presented in roll form.

The invention can also be applied to producing wallcoverings.

Another advantage of the invention is to propose flooring having good delamination properties.

To that end and according to the invention, flooring is proposed comprising a multilayer structure comprising successively at least one wear layer, a decorative layer and a sublayer, the decorative layer being in the form of a non-woven textile sheet impregnated with a binder and one of the faces of which comprises a decoration printed with ink.

The flooring thus obtained has a quality of decoration comparable to conventional techniques using rotogravure, while making it possible to print the decorative layer by means of an inkjet print method, also called a digital printing method. The combination of a binder and a non-woven textile sheet forms a print substrate that is particularly compatible with inkjet printing techniques. The non-woven textile sheet comprises fibers bound together by the binder. As a result of the low volume deposited by said technique the sprayed ink penetrates into the non-woven textile sheet without spreading. In said configuration, the binder makes it possible to make the bond between the non-woven textile sheet and the printed ink compatible with the wear layer and/or the sublayer, if applicable. Said compatibility is ensured irrespective of the type of ink used, particularly with water-based inks.

Preferably, the non-woven textile sheet is produced from a mixture comprising the binder and textile fibers.

According to one particular embodiment, the mixture of fibers and binder is then shaped into a sheet and dried, by any appropriate technique.

Advantageously, the non-woven textile sheet is produced from the binder and natural fibers, synthetic fibers, or synthetic mineral fibers.

The non-woven textile sheets are preferably obtained by means of a paper manufacturing method. This known method utilizes a latex type mixture containing water, surfactants and fibers, the mixture being spread onto a conveyor by blowing. The water in this mixture is then evacuated to obtain a moist sheet. The sheet is then peeled off the conveyor to be dipped into an ink fountain containing the binder. The binder then impregnates the moist sheet. The non-woven textile sheet is then obtained after an additional drying step. The non-woven textile sheet then comprises a mixture of fibers bound together by the binder.

The non-woven textile sheets that can be used according to the present invention are, in particular, non-woven textile sheets produced from natural fibers such as cellulose, cotton or linen fibers, or synthetic fibers such as polyester, aramid, Nomex, polyethylene naphthalate, polyethylene terephthalate or equivalent, or synthetic mineral fibers such as glass fibers or basalt fibers.

Natural fibers are available at low cost and enable the dimensional stability to be improved, such fibers being less sensitive to changes in temperature. Synthetic fibers make it possible to improve the flexibility of the flooring formed, depending on the applications desired.

Advantageously, the non-woven textile sheet is produced from a mixture of natural fibers and synthetic fibers and/or synthetic mineral fibers. The use of such a mixture enables improves resistance to peeling of the flooring obtained according to the invention, while having a good print rendering of the decorative layer. The mineral fibers make it possible both to improve the dimensional stability of the flooring thus formed, as well as its resistance to peeling. The use of water-based ink is also possible, the binder of the non-woven textile sheet enabling better adhesion with the wear layer and/or the sublayer. The flooring obtained can also be flexible for applications in roll form, or more rigid for applications in tile form, by modifying for example the composition of the sublayer and/or the wear layer, and/or the proportions of fibers and binder.

Advantageously, the non-woven textile sheet is produced from a mixture comprising 20% to 80% natural fibers and 20% to 80% synthetic fibers. Said proportions have particularly satisfying qualities of resistance to peeling of the flooring. Alternatively, the use of at least 20% natural fibers in combination with at least 20% synthetic fibers also makes it possible to improve resistance to peeling of the flooring thus obtained.

Advantageously, the non-woven textile sheet is produced from a mixture comprising 20% to 80% natural fibers and 20% to 80% synthetic mineral fibers. Alternatively, the use of at least 20% natural fibers in combination with at least 20% synthetic mineral fibers also makes it possible to improve resistance to peeling of the flooring thus obtained, as well as its dimensional stability.

The inks that can be used with the invention can be of different types, particularly dye inks or pigment inks. Said inks can also be photo cross-linkable, water-based or solvent-based.

Advantageously, the non-woven textile sheet comprises 15 to 50% binder by the total weight of the non-woven textile sheet. The proportion of binder by total weight of the non-woven textile sheet can be adapted according to the mixture of natural and synthetic and/or synthetic mineral fibers used. However, it is generally preferable to use a non-woven textile sheet comprising 20 to 50%, more preferably to 50% binder of total weight of the non-woven textile sheet in order to improve the resistance to peeling, for most of the types of fiber and binder used.

The binders that can be used according to the present invention are, in particular, thermally cross-linkable binders such as ethylene vinyl acetate (EVA) based binders. By way of examples, the binders that can be used are also styrene-acrylic (SA) based binders or acrylic-based binders such as polyvinyl acetate (PVAC) or polyvinyl chloride (PVC) or any equivalent thermoplastic binder.

Advantageously, the non-woven textile sheet has a grammage of between 20 and 80 g/m², preferably between 20 and 40 g/m². Indeed, it is preferable to use a non-woven textile sheet having a rather light grammage, particularly between 20 and 40 g/m², although this can vary by a few grams. A non-woven textile sheet with a grammage of between 20 and 40 g/m² makes it possible to limit the risks of the delamination of the flooring due to the non-woven textile sheet. Such low grammage ensures good penetration of the sublayer and of the wear layer during lamination and/or the coating of a plastisol onto the non-woven textile sheet.

The combination of a grammage between 20 and 40 g/m² and a binder proportion of between 20% and 50% makes it possible to limit the appearance of bubbles during the manufacture of the flooring, while guaranteeing good resistance to peeling.

Advantageously, the non-woven textile sheet comprises one face opposite the sublayer, which face is attached to a reinforcing frame. Said reinforcing frame improves the dimensional stability of the flooring. The combination of a grammage between 20 and 40 g/m² and a binder proportion of between 20% and 50% makes it possible to limit the appearance of bubbles due to the presence of a reinforcing frame during the manufacture of the flooring, while guaranteeing good resistance to peeling.

The invention also concerns a flooring manufacturing method comprising a multilayer structure including successively at least one wear layer, one decorative layer and one sublayer. The method according to the invention consists of printing a decoration on one of the faces of a non-woven textile sheet impregnated by a binder, by means of an inkjet printer spraying liquid ink to form the decorative layer, and of binding together the wear layer, the decorative layer and the sublayer to form the multilayer structure of the flooring.

Preferably, the non-woven textile sheet impregnated with a binder is produced from a mixture comprising the binder and textile fibers, for example, formed into a sheet and dried.

Conventional techniques for binding together the wear layer, the decorative layer and the sublayer can be used. By way of examples, said layers can be bound by lamination, gluing, hot gluing, pressing, coating.

Advantageously, the method according to the invention comprises at least one step consisting of:
coating the sublayer on a lower face of the decorative layer, and/or
coating the wear layer on an upper face of the decorative layer.

The invention also concerns the use of an inkjet printing method for printing a decoration on one of the faces of a non-web textile sheet impregnated with a binder in a flooring manufacturing method comprising a multi-layer structure including successively at least one wear layer, one decorative layer and one sublayer.

### BRIEF DESCRIPTION OF THE DRAWINGS

Other advantages and characteristics will be seen from the following description of several variants, provided by way of non-limiting examples, of flooring and of the manufacturing method thereof according to the invention, with reference to the appended drawings in which:

FIG. 1 illustrates, diagrammatically and in transverse cross-section, one embodiment of a multilayer structure according to the invention for producing flooring.

### DETAILED DESCRIPTION OF THE INVENTION

The invention concerns flooring comprising a multilayer structure comprising a decorative layer (2). The flooring according to the invention is of simple and inexpensive design and comprises a printed layer obtained by means of an inkjet printing method. The flooring according to the invention can be compatible with inks that do not emit volatile organic compounds (COV), particularly water-based inks. The flooring according to the invention can have any type of form, particularly panel or tile, or be in flexible form, particularly in roll form Possible applications of the flooring according to the invention can be aviation, or floors for buildings open to the public.

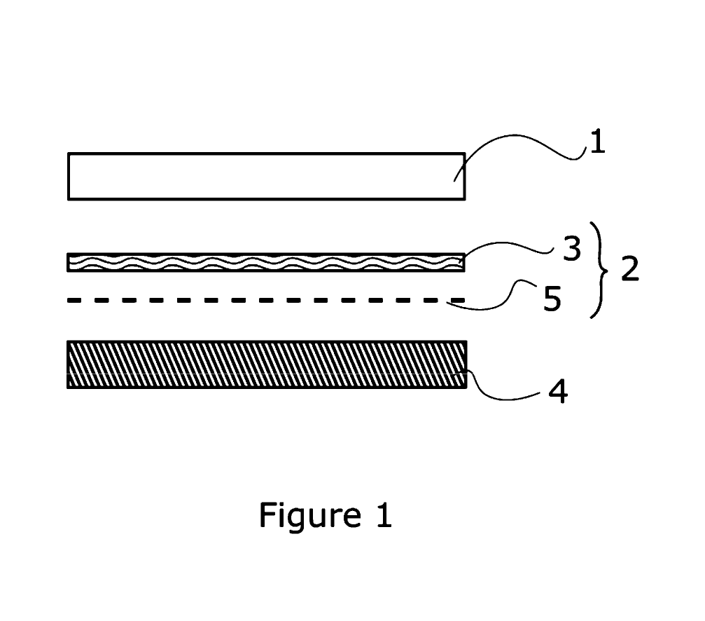

With reference to FIG. 1, the flooring according to the invention comprises a multilayer structure comprising successively at least a wear layer (1), a decorative layer (2) and a sublayer (4). The decorative layer (2) is in the form of a non-woven textile sheet (3) impregnated with a binder, and one face of said layer comprises a decoration printed with ink. The non-woven textile sheet (3) thus comprises fibers bound together by the binder. In practice, the non-woven textile sheet can be produced from a mixture comprising the binder and textile fibers, said mixture for example being then formed into a sheet and dried by any appropriate technique. Other techniques can be used. The binder can in particular be in the form of a liquid or a foam.

The printing of the decoration of the non-woven textile sheet can be performed by means of an inkjet printing method.

Thus, the structure of the flooring according to the invention remains simple while having a visual aspect comparable to floorings for which the decorative layer is printed by rotogravure.

Obviously additional layers can be added to the multilayer structure without modifying the object of the invention. By way of example, the multilayer structure can comprise a compensation layer attached to the sublayer and intended to be in contact with the ground. Said can in particular be of a plastic material, such as polyvinyl chloride, and preferably of a thickness of 2 mm. For example, to comply with U4 P3 classification of the French UPEC Standard, the compensation layer has a Shore A hardness of between 80 and 95. In order to confer acoustic and/or thermal insulation properties to the flooring or wall covering said compensation layer can also be a PVC or polyurethane foam. In the case where said compensation layer is foam, the density thereof is between 0.2 and 0.9.

According to another particular embodiment, the wear layer according to the invention can comprise a varnish, positioned on the face of the wear layer intended to be in contact with the user. Said optional protective layer can make it possible to improve the product's scratch-resistant or stain-resistant properties. Moreover, it can also offer a more matt surface finish to the product, which can be desirable in certain domains of application. In particular, it can be polyurethane or acrylic based, or mixtures thereof; and can advantageously have an area density between 5 and 50 g/m2.

Another advantage of the invention is to propose flooring having good delamination properties.

The grammage of the non-woven textile sheet is also important; it is therefore not desirable to use a non-woven textile sheet having a grammage of more than 80 g/m², at the risk of decreasing the resistance to delamination.

Advantageously, the grammage of the non-woven textile sheet is between 20 and 80 g/m², preferably between 20 and 40 g/m², in order to obtain a printed decoration having a good visual aspect as well as flooring having good values of resistance to delamination.

Advantageously, the characteristics of the wear layer and/or sublayer of the flooring according to the invention are as follows:

As regards their composition, they conventionally comprise a polymer. The polymer most commonly used is a vinyl based polymer such as polyvinyl chloride (PVC), possibly in combination with polyvinyl butyrate (PVB), or polyvinyl acetate (PVA). Polyolefins can also be used. Polyurethane (PU) is also an alternative to PVC, obtained by cross-linking between castor oil or glycerol and an isocyanate, as described in patent EP 2 307 609. Another alternative concerns the use of linoleum.

Furthermore, they can contain at least one additive chosen from the following group: plasticizers, mineral fillers, thermal or UV stabilizers, desiccants, lubricants, processing aids, pigments, flame retardant agents.

The mineral fillers can be chosen from the group comprising calcium carbonate, chalk, kaolin, barium sulfate, talcum, aluminum trihydrates, wood meal or ground cork, or silica.

The plasticizers can be chosen from the group comprising high molecular weight ortho-phthalates such as DIDP (diisodecyl phthalate), terephthalates, sebacates (for example dibutyl sebacate or DBS), adipates.

Preferably, and to enhance the mechanical performance and resistance to indentation and rolling and to allow better dimensional stability of the flooring over time, the non-woven textile sheet (3) comprises one side facing the sublayer (4), which face is connected to a reinforcing frame (5) such as a grid or a fiberglass mat.

Said reinforcement (5) has for example the form of a grid or screen of textile yarns of negligible thickness, or a fiberglass mat. The textile yarns of said reinforcing frame (5) preferably have a thread count of more than 2×2, and the grist of the warp and weft yarns is between 34 and 136 tex. The reinforcement frame (5) enables an increase in the mechanical performance and resistance of the flooring to indentation and rolling. The reinforcement frame (5) ensures a better dimensional stability of the covering over time. According to another technique, the reinforcing frame (5) can be embedded in the upper face of the sublayer (4), which sublayer (4) is then made integral with the face of the non-woven textile (3) opposite the sublayer (4).

Tests have been carried out by the applicant with twelve examples of different multilayer structures, namely the constructions #1 to #12, in which several types of non-woven textile sheet (3) were tested in order to measure the delamination value of said non-woven textile sheet to the sublayer (3) and/or the wear layer (1).

Each tested construction comprises, in the direction from the wear layer (1) towards the sublayer (4):
a transparent wear layer (1) made of PVC, with a thickness of about 0.65 mm.
a decorative layer (2) in the form of a non-woven textile sheet impregnated with a binder, and one face of said layer comprises a decoration printed with ink.
a sublayer produced from PVC (4), with a thickness of about 0.90 mm.

The total thickness of each construction thus obtained is about 2 mm.

The wear layer or sublayer can each be produced independently by pressing, calendaring or coating. The different constructions can then be produced by laminating together the wear layer, decorative layer and sublayer. Alternatively, the wear layers and/or sub layers can be obtained by coating on a conventional support, then laminating, and/or by coating on the non-woven textile sheet.

Each wear layer or sublayer can potentially be embossed.

The binders tested are, in particular, thermally cross-linkable binders such as binders based on ethylene vinyl acetate (EVA) binders based on styrene acrylic (SA) or acrylic (A) based binders. Other types of binders can be used, particularly binders based on polyvinyl acetate (PVAC) or polyvinyl chloride (PVC).

For each of the constructions #1 to #12, the percentage of binder is given in total weight of the non-woven textile sheet (3) obtained.

Construction #1 comprises a non-woven textile sheet the fibers of which are a mixture of 65% cellulose fibers and 35% polyester fibers and the binder proportion of which is 20%, the binder being an EVA binder. The grammage of the non-woven textile sheet thus obtained is 25.1 g/m².

Construction #2 comprises a non-woven textile sheet the fibers of which are a mixture of 70% cellulose fibers and 30% polyester fibers and the binder proportion of which is 20%, the binder being an SA binder. The grammage of the non-woven textile sheet thus obtained is 20.3 g/m².

Construction #3 comprises a non-woven textile sheet the fibers of which are a mixture of 65% cellulose fibers and 30% polyester fibers and the binder proportion 5of which is 20%, the binder being an SA binder. The grammage of the non-woven textile sheet thus obtained is 30.2 g/m².

Construction #4 comprises a non-woven textile sheet the fibers of which are a mixture of 80% cellulose fibers and 20% polyester fibers and the binder proportion 5 of which is 35%, the binder being an SA binder. The grammage of the non-woven textile sheet thus obtained is 25 g/m².

Construction #5 comprises a non-woven textile sheet the fibers of which are a mixture of 55% cellulose fibers and 45% polyester fibers and the binder proportion of which is 45%, the binder being an SA binder. The grammage of the non-woven textile sheet thus obtained is 30 g/m².

Construction #6 comprises a non-woven textile sheet the fibers of which are a mixture of 26% cellulose fibers and 74% polyester fibers and the binder proportion of which is 30%, the binder being an SA binder. The grammage of the non-woven textile sheet thus obtained is 35 g/m².

Construction #7 comprises a non-woven textile sheet the fibers of which are a mixture of 22% cellulose fibers and 78% polyester fibers and the binder proportion of which is 25%, the binder being an A binder. The grammage of the non-woven textile sheet thus obtained is 35 g/m².

Construction #8 comprises a non-woven textile sheet the fibers of which are a mixture of 41% cellulose fibers, 44% polyester fibers and 15% glass fibers and the binder proportion of which is 25%, the binder being an A binder. The grammage of the non-woven textile sheet thus obtained is 30 g/m².

Construction #9 comprises a non-woven textile sheet the fibers of which are a mixture of 57% cellulose fibers and 42% glass fibers and the binder proportion of which is 20%, the binder being an EVA binder. The grammage of the non-woven textile sheet thus obtained is 30 g/m².

Construction #10 comprises a non-woven textile sheet the fibers of which are a mixture of 70% cellulose fibers and 30% polyester fibers and the binder proportion of which is 15%, the binder being a PVC binder. The grammage of the non-woven textile sheet thus obtained is 20.7 g/m².

Construction #11 comprises a non-woven textile sheet the fibers of which are a mixture of 70% cellulose fibers and 30% polyester fibers and the binder proportion of which is 36%, the binder being a PVC binder. The grammage of the non-woven textile sheet thus obtained is 28.3 g/m².

Construction #12 comprises a non-woven textile sheet the fibers of which are a mixture of 55% cellulose fibers and 45% polyester fibers and the binder proportion of which is 36%, the binder being a PVC binder. The grammage of the non-woven textile sheet thus obtained is 26.6 g/m².

The method according to the invention enabling constructions #1 to #12 consists of printing a decoration on one of the faces of each non-woven textile sheet impregnated by a binder, by means of an inkjet printer spraying liquid ink to form the decorative layer, and of binding together, for example by hot pressing, the wear layer, the decorative layer and the sublayer to form the multilayer structure of the flooring.

Advantageously, and to improve the resistance to delamination between the different layers of the flooring according to the invention, the flooring according to the invention can comprise at least one wear layer and/or one sublayer obtained by coating. The method then comprises at least one step which consist of:
coating the sublayer on a lower face of the decorative layer, and/or
coating the wear layer on an upper face of the decorative layer.

The coating of the sublayer and/or the wear layer is produced from a plastisol, particularly a PVC plastisol. Advantageously, the viscosity of the plastisol is between 1000 and 10000 centipoises (at about 30° C.), the viscosity being measured by Brookfield (20 rpm). In order to improve the penetration of the plastisol in the non-woven textile sheet, the viscosity of the plastisol can be reduced between 1000 and 6000 centipoises. Better penetration of the plastisol makes it possible to improve resistance to delamination between layers of the flooring.

Advantageously, and whether by a laminating or coating method, one face or both faces of the wear layer and/or the sublayer can be embossed in order to present a particular surface aspect, to improve the non-slip conditions, and to improve the delamination value between layers of the flooring thus obtained.

The ink used is a solvent-free photo cross-linkable ink of the VUTEK® superflex or VUTEK® triangle line, printed by a VUTEK® inkjet printer marketed by the EFI company. The ECO UV inks marketed by the ROLAND company and the latex water-based inks, reference HP881 and HP891, marketed by the Hewlett-Packard Company, have also been successfully tested. Because the ink is printed directly onto the non-woven textile sheet, different types of inks can be used while preserving good delamination values, particularly dye inks or pigment inks. Said inks can also be either water-based or solvent-based.

Table 1 summarizes the compositions of the non-woven textile sheets of the constructions #1 to #12.

TABLE 1

| | | Binder | |
|---|---|---|---|
| | | proportion | Nature of |
| Construction | Fiber proportion | (%) | the binder |
| #1 | 65% cellulose/35% polyester | 20 | EVA |
| #2 | 70% cellulose/30% polyester | 20 | SA |
| #3 | 65% cellulose/35% polyester | 20 | SA |
| #4 | 80% cellulose/20% polyester | 35 | SA |
| #5 | 55% cellulose/45% polyester | 45 | SA |
| #6 | 26% cellulose/74% polyester | 30 | SA |
| #7 | 22% cellulose/78% polyester | 25 | A |
| #8 | 41% cellulose/44% polyester/ | 25 | A |
| | 15% glass | | |
| #9 | 57% cellulose/42% glass | 20 | EVA |
| #10 | 70% cellulose/30% polyester | 15 | PVC |
| #11 | 70% cellulose/30% polyester | 36 | PVC |
| #12 | 55% cellulose/45% polyester | 36 | PVC |

Table 2 presents the delamination test results performed on the constructions #1 to #12, the wear layer and sublayer being obtained by calendaring, then hot laminated in a press in order to be attached to each of the decorative layers.

TABLE 2

| | Delamination value in |
|---|---|
| Construction | N/cm lamination |
| #1 | 0.44 |
| #2 | 0.36 |
| #3 | 0.40 |
| #4 | 0.42 |
| #5 | 0.53 |
| #6 | 0.66 |
| #7 | 0.39 |
| #8 | 0.78 |
| #9 | 0.74 |
| #10 | 0.37 |
| #11 | 0.76 |
| #12 | 0.74 |

Table 3 presents the delamination test results performed on the constructions #3, #10 and #12 obtained by coating wear layers and sub layers on each non-woven textile sheet. The wear layer is also embossed.

TABLE 3

| | Delamination value in N/cm |
|---|---|
| Construction | coating followed by graining |
| #3 | 0.67 |
| #10 | 0.57 |
| #11 | 0.78 |

The delamination value, also called resistance to peeling value, is measured according to standard NF EN ISO 24345 and given in N/cm.

These different tests and constructions show that the resistance to delamination of the flooring according to the invention is suitable for building construction applications. The aspect of the decoration obtained is similar to that of decoration obtained by rotogravure, while simplifying the structure of the flooring and having good flexibility as well as good dimensional stability, irrespective of the type of ink used.

The coating method used for constructions #3, #10, #11, and consisting of printing a decoration on one of the faces of a non-woven textile sheet impregnated with a binder, by an inkjet printer spraying a liquid ink in order to form a decorative layer, then of:
coating the sublayer on a lower face of the decorative layer, and
coating the wear layer on an upper face of the decorative layer makes it possible to obtain higher delamination values and thus enables flooring to be obtained for high traffic applications where the floor covering is particularly stressed.

The different percentages of binder of total weight of the non-woven textile sheet (3) that were tested show good results when the non-woven textile sheet comprises from 15% to 50% binder of total weight of the non-woven textile sheet (3).

Advantageously, and in order to improve the resistance to delamination, the non-woven textile sheet comprises from 25% to 50% binder of total weight of the non-woven textile sheet, more preferably from 30% to 50% binder of total weight of the non-woven textile sheet.

The constructions #3, #6, #8, #9, #11, #12 are preferred insofar as they enable a resistance to peeling to obtained of more than 0.60 N/cm while allowing a good compromise in terms of dimensional stability, limitation of appearance of bubbles and ease of production

The constructions#8, #9, #11, #12 are particularly preferred because they enable a resistance to peeling of more than 0.70 N/cm to be obtained, allowing them to be used in very high traffic applications.

Lastly, it is clear that the examples that have just been given are only specific illustrations and are by no means limiting as concerns the domains of application of the invention.

1. A flooring comprising a multilayer structure comprising successively at least one wear layer, a decorative layer and a sublayer, wherein the decorative layer is in the form of a non-woven textile sheet impregnated with a binder, wherein one face of said non-woven textile sheet comprises a decoration printed with ink.

2. The flooring according to claim 1, wherein the non-woven textile sheet impregnated with a binder is produced from a mixture comprising the binder and textile fibers.

3. The flooring according to claim 1, wherein the non-woven textile sheet is produced from the binder and natural fibers, synthetic fibers, or synthetic mineral fibers.

4. The flooring according to claim 3, wherein the non-woven textile sheet is produced from a mixture of natural fibers with synthetic fibers and/or synthetic mineral fibers.

5. The flooring according to claim 4, wherein the non-woven textile sheet is produced from a mixture comprising 20% to 80% natural fibers and 80% to 20% synthetic fibers.

6. The flooring according to claim 3, wherein the synthetic fibers are polyester fibers.

7. The flooring according to claim 4, wherein the non-woven textile sheet is produced from a mixture comprising 20% to 80% natural fibers and 80% to 20% synthetic mineral fibers.

8. The flooring according to claim 3, wherein the mineral synthetic fibers are glass fibers.

9. The flooring according to claim 3, wherein the natural fibers are cellulose fibers.

10. The flooring according to claim 1, wherein the non-woven textile sheet comprises 15% to 50% binder of total weight of the non-woven textile sheet.

11. The flooring according to claim 1, wherein the binder is based on ethylene-vinyl acetate, styrene acrylic, acrylic or polyvinyl chloride.

12. The flooring according to claim 1, wherein the non-woolen textile sheet has a grammage of between 20 and 40 g/m².

13. The flooring according to claim 1, wherein the non-woven textile sheet comprises one face opposite the sublayer, which face is connected to a reinforcing frame.

14. A method of manufacturing flooring comprising a multilayer structure successively including at least one wear layer, a decorative layer and a sublayer, said method comprising printing a decoration on one of the faces of a non-woven textile sheet impregnated with a binder by means of an inkjet printer spraying a liquid ink in order to form the decorative layer, and binding together the wear layer, the decorative layer and the sublayer to form the multilayer structure of the flooring.

15. The method according to claim 14, wherein the non-woven textile sheet impregnated with a binder is produced from a mixture comprising the binder and textile fibers.

16. The method according to claim 15, wherein the mixture of fibers and binder is formed into a sheet and dried.

17. The method according to claim 14, comprises at least one step consisting of:
coating the sublayer on a lower face of the decorative layer, and/or
coating the wear layer on an upper face of the decorative layer.

18. The flooring according to claim 4, wherein the synthetic fibers are polyester fibers.

19. The flooring according to claim 5, wherein the synthetic fibers are polyester fibers.
